(19) United States
(12) Patent Application Publication
(10) Pub. No.: US 2018/0108234 A1
(43) Pub. Date: Apr. 19, 2018

(54) MOBILE SMOKE AND FIRE DETECTION SYSTEM AND METHOD

(71) Applicant: Minddust labs LLC, Kansas City, MO (US)

(72) Inventor: Christopher Cichon, Lenexa, KS (US)

(73) Assignee: MindDust labs LLC, Kansas City, MO (US)

(21) Appl. No.: 15/782,634

(22) Filed: Oct. 12, 2017

Related U.S. Application Data
(60) Provisional application No. 62/410,102, filed on Oct. 19, 2016.

(51) Int. Cl. G08B 17/103; G08B 25/01; G08B 25/10

(52) U.S. Cl. CPC G08B 17/103; G08B 17/06; G08B 25/10; G08B 25/016

(57) ABSTRACT

A mobile smoke and fire detection system and method is described. By integrating a variety of sensors and alarm capabilities into an application running on a mobile computing device, tablet, pager, or transceiver a situationally-aware mobile smoke, fire and other anomalous event-detection approach is provided.

### BACKGROUND

### Field

The present invention relates to smoke detection, and, more particularly, to a situationally-aware mobile smoke detection system and method.

### Background

Early indication of smoke continues to be desirable in the prevention of injuries and death where fire may be present. Such an early indication is desirable for personnel with normal sight. It is also desirable for people with sight challenges, or for personnel in circumstances where the environments are themselves visually challenging.

### BRIEF SUMMARY

This section is for the purpose of summarizing some aspects of the present disclosure and to briefly introduce some preferred embodiments. Simplifications or omissions may be made to avoid obscuring the purpose of the section. Such simplifications or omissions are not intended to limit the scope of the present disclosure. Consistent with the principles of the present disclosure as embodied and broadly described herein.

In some embodiments, a system is described that uses a mobile processing device that is coupled to a sensor, where the sensor is one or more of a luminosity sensor, an inertial measurement unit, an optical sensor or a barometer. Also coupled to the mobile processing device is one or more of a smoke sensor or a carbon monoxide sensor. Coupled to the mobile processing device is an output interface that includes at least one of a screen, light emitting device, a tactile interface, a speaker, and a flashlight. Also provide in the system is an output communications module configured to produce one or more of an e-mail, initiate an application, an SMS text message and a communication to an E-911 entity based on the detection of smoke in the immediate environment. The detection is performed by the mobile processing device that is configured to receive input from the at least one of a luminosity sensor, an inertial measurement unit, an optical sensor or a barometer, to receive input from one or more of a smoke sensor or a carbon monoxide sensor, and thereby determines a presence of smoke in an immediate environment of the mobile processing device.

Further features and advantages of the disclosure, as well as the structure and operation of various embodiments of the present disclosure, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an exemplary implementation of a mobile smoke detection system, in accordance with embodiments of the present invention.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The disclosure will be better understood from the following descriptions of various “embodiments” of the disclosure. Thus, specific “embodiments” are views of the disclosure, but each does not itself represent the whole disclosure. In many cases individual elements from one particular embodiment may be substituted for different elements in another embodiment carrying out a similar or corresponding function. It is to be appreciated that the Detailed Description section, and not the Summary and Abstract sections, is intended to be used to interpret the claims. The Summary and Abstract sections can set forth one or more but not all exemplary embodiments of the present disclosure as contemplated by the inventor(s), and thus, are not intended to limit the present disclosure and the appended claims in any way.

There are numerous scenarios in which visual challenges result in difficulties in the detection of the presence of smoke. For example, a blind person is unable to determine the presence of smoke based on any visual cues. Similarly, a solider in the darkness of a battlefield may not able to detect the presence of smoke. It is desirable to employ advanced technology to provide support for blind persons, soldiers and others in visually challenging environments. In particular, it is desirable to provide a means to sense, and act upon, the conditions in a person's immediate environment in real-time and on a continuous basis.

Embodiments of the present disclosure provides a sensory system that uses mobile devices to provide enhanced sensory capabilities for individuals in visually challenging environments. Embodiments include a mobile communications device (e.g., wireless phone, tablet) that is coupled to a number of sensors that provide input relevant to the detection of smoke. Upon the detection of smoke in the immediate environment, the sensory system may alert the user of the sensory system using one of a variety of methods. The sensory system may also initiate communications via e-mail, via the use of an application or an SMS text message. The sensor system may also contact external parties, including emergency response personnel using E-911 or equivalent communications. Finally, the sensor system may also store the sensed data and resulting actions in a database coupled to the sensory system. All of these capabilities may be performed in real-time and on a continuous basis.

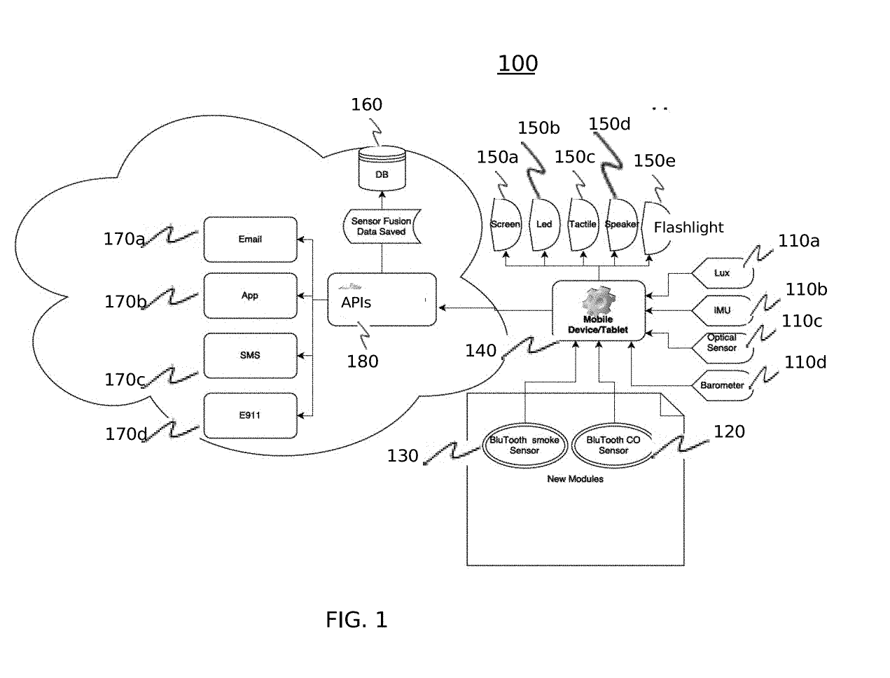

FIG. 1 illustrates an exemplary implementation of a sensory system 100 to detect smoke in the immediate environment. Sensory system 100 includes mobile device/tablet 140 that are coupled to one or more sensors 110. Sensors 110 include luminosity sensor 110a, inertial measurement unit 110b, optical sensor 110c, and barometer 110d. Sensors 110 may be coupled using wireless or wireline connectivity. Luminosity sensor 110a may detect loss of local light intensity consistent with the presence of smoke. Similarly, optical sensor 110c may detect light conditions consistent with the presence of smoke. Optical sensor 110c may also detect the flame associate with a fire. Inertial measurement unit 110b is receptive to movements such those induced by an explosion, an earthquake, or similar anomalous event. A similar event may include any event that generates an acoustic wave having a particular signature that is recognized as an event associated with danger or other occurrence of note. Barometer 110d detects change in local pressure consistent with the presence of fire and smoke. Also coupled to mobile device/tablet 140 is smoke sensor 130 and/or carbon monoxide sensor 120. Smoke sensor 130 and/or carbon monoxide sensor 120 may connect to device/tablet 140 via the Bluetooth protocol. Other types of electronic coupling with the sensors fall within the scope of embodiments of the approaches described herein. For example, the connectivity may be provided with wireline, Zigbee and more generally any type of wired or wireless type of connectivity. Even more generally, the connectivity may be provided via the internet or local area network irrespective of how the physical connectivity is made. Thus, for example, the internet of things (IoT) is within the approach described herein, whereby the internetworking of physical devices, smart devices, vehicles, buildings and other items (complete with electronics, software, sensors, actuators, and network connectivity) such that these objects may collect data and provide it back to a central location. Thus, for example if a Fire Fighter Battalion commander needed to communicate to Emergency Personal, the communication would be sent to all of the Emergency Personal to evacuate with a tactile or bone conduction signal. To verify that all personal received the communication they transceivers would act as a mesh network until Personal's hardware reviewed the Alert/communication.

Mobile device/tablet 140 processes the input data received from the coupled sensors 110 and determines the presence of smoke and/or fire, or other significant events, in the local environment. A determination of smoke, fire or other significant event is made using processing of the sensor data using trained neural models and computer vision modeling. The neural models encompass significant learning based on training of those models, and are able to exploit a limited or a wide variety of input data and make intelligent decisions based on the available real-time data and potentially known a priori conditions.

Mobile device/tablet 140 is not limited to such device as iPads and the like. More generally, this module may be a component of any cloud-based surveillance system, such as would be in use in a factory, in an industrial plant, or even a home surveillance system. These systems are coupled to a wide variety of sensors that are configured to capture signals that are indicative of a problem, an emergency or other anomaly that needed to be addressed. For example, a typical ethanol plant has numerous sensors that are coupled to a central system where the sensors are spatially distributed around the entirety of the plant, and are selected to capture anomalous events, such as fire, smoke, explosions, and the like. By using neural network trained models, distinctions may be analyzed that lead to a determination that an anomaly has occurred.

Mobile device/tablet 140 may alert the user through one or more output interfaces 150. Output interfaces 150 include visual screen 150a, light emitting device (LED) 150b, tactile output 150c, speaker 150d, and flashlight 150e. Visual screen 150a provides a visual cue to the presence of smoke. Similarly, light emitting device (LED) 150b also provides a visual cue to the presence of smoke and/or fire. Tactile output 150c alerts the use via the sense of touch as to the presence of smoke. Speaker 150d alerts the use via sound as to the presence of smoke and/or fire. Finally, flashlight 150e (e.g., flashing light, colored lights indicative of an emergency, or other light indicative of an emergency) alerts the user as to the presence of smoke and/or fire.

Mobile device/tablet 140 may also communicate with external parties via application programmer interfaces (APIs) 180 upon the determination of the presence of smoke in the local environment. For example, mobile device/tablet 140 may send an e-mail 110a, invoke an application 110b, send an SMS/text message 110c and/or communicate with emergency service personal via E-911. Finally, mobile device/tablet 140 may also store the sensed data and resulting actions in a database 160 coupled to mobile/device/tablet 140. Database 160 captures the on-going stream of relevant data, and may be used for subsequent training of neural models, as well as any post-anomalous event examination and/or debriefing. Application 110b includes the notion of applications that may be triggered upon a determination of an anomalous event. For example, application 110b may include a map application that provides information on escape routes. Other examples of application 110b include applications to initiate a shutdown procedure in a factory plant.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system comprising:
a mobile processing device;
a sensor coupled to the mobile processing device, the sensor including at least one of a luminosity sensor, an inertial measurement unit, an optical sensor or a barometer;
one or more of a smoke sensor or a carbon monoxide sensor, the one or more of a smoke sensor or a carbon monoxide sensor coupled to the mobile processing device;
an output interface coupled to the mobile processing device, the output interface including at least one of a screen, light emitting device, a tactile interface, a speaker, and a flashlight;
an output communications module configured to produce one or more of an e-mail, initiate an application, an SMS text message and a communication to an E-911 entity,
wherein the mobile processing device is configured to receive input from the at least one of a luminosity sensor, an inertial measurement unit, an optical sensor or a barometer, receive input from one or more of a smoke sensor or a carbon monoxide sensor, and to determine a presence of smoke in an immediate environment of the mobile processing device.
